(19) United States
(12) Patent Application Publication
(10) Pub. No.: US 2014/0182458 A1
(43) Pub. Date: Jul. 3, 2014

(54) Microwave Beverage Cartridge Holder

(71) Applicant: Obed Fernandez, Kissimmee, FL (US)

(72) Inventor: Obed Fernandez, Kissimmee, FL (US)

(21) Appl. No.: 13/731,390

(22) Filed: Dec. 31, 2012

(51) Int. Cl. A47J 31/40

(52) U.S. Cl. CPC A47J 31/407
USPC 99/295; 99/323

(57) ABSTRACT

This microwave beverage cartridge holder is designed with the intention of facilitating the process of making a single cup of any hot beverage. This invention overcomes the necessity of specific or more complex machines in order to produce a single cup of hot beverage. In addition to saving energy and money as part of its benefits, this invention is made with eco friendly materials as well.

### BACKGROUND DISCUSSION

1. Field of the Invention

This invention relates generally to single serve beverage machines, and is concentrated in particular with the provision of a microwave beverage cartridge holder to be used in microwaves.

2. Prior Art

Previously, many devices have been proposed for brewing hot beverages in microwaves; however none of these devices can brew from holding a beverage filter cartridge. U.S. Pat. No. 5,010,221 Grossman, et al. A drip-type coffee maker adapted for use in a microwave oven. The coffee maker includes a container which can dispense coffee directly into a receptacle there below and has an upper reservoir for holding water, a lower filter element for holding coffee grounds and a partition, which separates the reservoir and coffee filter element. The partition includes a portion thereof adapted to close and open communication between the reservoir and the filter element, and a non-toxic heat responsive sealing substance adapted to releasable seal the partition portion in the closed position until water in the reservoir reaches a temperature for brewing coffee. When the water in the reservoir reaches a desired brewing temperature, the heat responsive seal releases the portion by melting, dissolving or the like, opening the reservoir to the filter element to the flow of the heated water into and through the filter element and coffee grounds to produce freshly brewed coffee which can be directly dispensed into a receptacle there below.

U.S. Pat. No. 5,095,185 issued to Fuchs, Jr. an apparatus for brewing coffee or the like with microwave energy comprising a generally funnel-shaped reservoir having an open upper end, a closed lower end and an aperture near the closed lower end. A removable cover is provided for closing the open upper end. A flange extends outwardly from the reservoir and is operable to position the apparatus over a conventionally-known cup or mug wherein the aperture is disposed over the cup or mug. A valve is provided to control flow of liquid from the reservoir and is operable to allow flow upon the existence of a predetermined condition in the reservoir.

U.S. Pat. No. 5,281,785 issued to Pasbrig a device for preparing hot drinks from a liquid and a drink medium, with a liquid container (1) holding the liquid and a drink medium container (2) holding the drink medium (7), wherein the heated liquid is conveyed through the drink medium container into a drink container (3) holding the hot drink. The liquid container (1) is closed so that it is substantially vapor-tight and has an overflow (10) which is directed into the drink medium container (2). At least the liquid container (1) is made of a material which is permeable to microwaves.

U.S. Pat. No. 5,300,743 issued to Park a microwave coffee maker includes a magnetron for generating microwaves that heat water flowing in a conduit toward a filtering vessel. A high voltage transformer is connected to the magnetron. The conduit extends in heat exchange relationship with the magnetron and transformer so that water flowing in the conduit absorbs heat from, and thereby cools, the magnetron and transformer.

U.S. Pat. No. 5,434,392 issued to Belinkoff a brewing apparatus which makes coffee by the drip method within a microwave oven. The brewing apparatus having a reservoir for retaining a quantity of water for heating. The reservoir positioned on a carafe for receiving a quantity of brewed coffee therein. A basket is positioned between the reservoir and the carafe for retaining the coffee grounds while permitting brewed coffee to pass there through. A water transfer tube is positioned within the reservoir having an inlet adjacent the internal bottom of the reservoir and an outlet positioned below the external bottom of the reservoir. The tube forming a bight above the water line within the reservoir. The application of microwave energy heats the water within the reservoir initiating a pumping system that creates a hydraulic head advantage through the transfer tube. The advantage creates a continuous flow of water from the reservoir through the outlet and onto the coffee grounds within the basket. The brewed coffee, created by the continuous contact between the heated water and the coffee grounds, passes from the basket into the carafe.

U.S. Pat. No. 5,545,879 issued to Brotz a device and method for the brewing of a cup of coffee from ground coffee by using a container disposed in a cup containing water, such container having a bottom with a sieve mesh therein which receives water from the cup there through with the sides of the container extending above the surface of the water. Coffee is placed in the container and floats on the water to be roasted while being heated in a microwave oven which heating also then brews the coffee beverage. When the coffee is brewed to taste, the container is then lifted out of the cup and any remaining undissolved ground coffee is strained out of the brewed coffee by the sieve mesh in the bottom of the container.

U.S. Pat. No. 5,747,782 issued to Orrico, et al. according to the present invention, water is placed in a water reservoir constructed of plastic microwave-transparent, pressure-resistant material. A funnel positioned on the upper surface of filter compartment is supported on the upper edges of the water reservoir with the spout extending downwardly into the water reservoir. A lower filter is placed into the filter compartment, and coffee grounds or other espresso particulate substance is placed on upper surface of the lower filter. An upper filter is then positioned on the upper surface of filter compartment to restrain the coffee grounds or other particular substance during brewing. A filtrate reservoir is placed over the funnel, and twisted, thereby engaging threads to join the water reservoir and the filtrate reservoir. A filtrate splash cover is attached to the upper edges of the filtrate reservoir. The assembled espresso device is placed into a microwave oven. As water in the water reservoir begins to boil, steam is generated, and boiling water is displaced upwards through the funnel and grounds, forming espresso. The filtrate splash cover provides for both venting and fluid retention during brewing. A resilient gasket, in conjunction with a plurality of vent passages, provides an additional means for pressure relief. The espresso is automatically emptied into the filtrate reservoir, which is designed to function as a drinking cup for individually-sized portions.

U.S. Pat. No. 5,832,809 issued to Gras a coffee maker to be used in conjunction with a field of microwave radiation. An upper tubular reservoir is removable mounted to a lower tubular reservoir through the use of a connecting member that holds a valve assembly centrally therein. A coffee filter basket assembly is mounted within lower tubular reservoir below the valve assembly. A cap with an opening prevents spillage of hot water and the buildup of pressure in the upper tubular reservoir member.

U.S. Pat. No. 5,880,441 issued to Hartman, et al. a beverage-brewing apparatus is provided which includes an outer cup member and an inner cup member. The outer cup member includes an open top, a sidewall and a bottom. The inner cup member has a sidewall, a first seal and a basket portion, with the sidewall of the inner cup member dimensioned to fit within the sidewall of the outer cup member. The first seal is disposed along an outer surface of the inner cup member for engaging the inner sidewall of the outer cup member to form a seal while still permitting the inner cup member to move within the outer cup member. The basket portion of the inner cup member is disposed at the bottom of the inner cup member. The basket portion includes a base with at least one aperture and a first filter medium, a sidewall, and a cap member having at least one aperture and a second filter medium. The cap member is releasable connected to the sidewall of the basket portion so that brewing material can be securely retained within the basket portion between the filter medium. The inner cup member is slid able between a first upper position where the basket portion of the inner cup member is disposed above the base of the outer cup member and a second lower position where the basket portion of the inner cup member is disposed against the base of the outer cup member such that liquid is forced through the basket portion when the inner cup member moves between the first and second positions with the first seal engaging the sidewall of the outer cup member. The apparatus preferably includes a lid having an aperture which is secured to the apparatus to close the apparatus.

U.S. Pat. No. 5,884,551 issued to Orrico, et al. a removable filter compartment is filled with coffee grounds, tea, or other espresso particulate substance and mounted within a water reservoir. Water is placed in the water reservoir. A bottom cover is connected to the water reservoir to hold the filter compartment in place. Lower and upper filters are formed into the filter compartment. The lower filter may include a slotted flow distribution port extending into the interior of the filter compartment to improve the distribution of water flow. A cup-like filtrate reservoir is integrally molded to the water reservoir. A filtrate passage forms a fluid path between the filter compartment and the filtrate reservoir. A resilient gasket or valve is positioned between the filter compartment and filtrate passage. A filtrate splash cover may be attached to the upper edges of the filtrate reservoir. The assembled beverage maker is placed into a microwave oven. As water in the water reservoir begins to heat up, steam is generated, and hot water is displaced upwards through the filter compartment and particulate substance. The heated beverage is automatically emptied into the filtrate reservoir, which is designed to function as a drinking cup for individually-sized portions.

U.S. Pat. No. 5,902,620 issued to Nolan an apparatus for preparing beverages comprises a liquid container and a drink medium container including a housing having a tubular member extending downward into the liquid container. The drink medium container includes a filter apparatus capable of containing a drink medium. A drink container includes a tubular liquid inlet in fluid flow communication with the drink medium container. The liquid container is in fluid communication with the drink container such that when liquid in the liquid container is heated, the liquid can flow upward from the liquid container through the tubular member, filter apparatus, and through the tubular liquid inlet into the drink container. The liquid container includes a double wall construction to maintain the temperature on an outer surface thereof at a relatively low level. The drink container includes an outer surface having longitudinally extending grooves which function to direct steam venting from the liquid container upwardly and away from the outer surface of the liquid container.

U.S. Pat. No. 5,942,143 issued to Hartman, et al. a beverage-brewing apparatus is provided which includes an outer cup member and an inner cup member. The outer cup member includes an open top, a sidewall and a bottom. The inner cup member has a sidewall, a first seal and a basket portion, with the sidewall of the inner cup member dimensioned to fit within the sidewall of the outer cup member. The first seal is disposed along an outer surface of the inner cup member for engaging the inner sidewall of the outer cup member to form a seal while still permitting the inner cup member to move within the outer cup member. The basket portion of the inner cup member is disposed at the bottom of the inner cup member. The basket portion includes a base with at least one aperture and a first filter medium, a sidewall, and a cap member having at least one aperture and a second filter medium. The cap member is releasable connected to the sidewall of the basket portion so that brewing material can be securely retained within the basket portion between the filter medium. The inner cup member is slid able between a first upper position where the basket portion of the inner cup member is disposed above the base of the outer cup member and a second lower position where the basket portion of the inner cup member is disposed against the base of the outer cup member such that liquid is forced through the basket portion when the inner cup member moves between the first and second positions with the first seal engaging the sidewall of the outer cup member. The apparatus preferably includes a lid having an aperture which is secured to the apparatus to close the apparatus.

U.S. Pat. No. 7,217,908 issued to Orrico, et al. a removable filter/pod compartment is filled with coffee grounds, tea, or other espresso particulate brewing substance and mounted within a water reservoir. Water is placed in the water reservoir. A bottom cover is connected to upper cup assembly to hold the filter/pod compartment in place. A resilient gasket or valve is positioned between the filter/pod compartment and a filtrate passage. A filtrate splash cover may be attached to the upper edges of the filtrate reservoir. The assembled beverage maker is placed into a microwave oven. As water in the water reservoir begins to heat up, steam is generated, and hot water is displaced upwards through the filter/pod compartment and particulate brewing substance. The heated beverage is automatically emptied into the filtrate reservoir, which is designed to function as a drinking cup for individually-sized portions.

U.S. Pat. No. 7,318,372 issued to Cooke a beverage making apparatus for preparing a plurality of different beverages, the apparatus comprising: a receptacle station for receiving a receptacle for the beverage; a capsule receiving station having walls defining a cavity for receiving a capsule containing a beverage making ingredient; an inlet for introducing water into a capsule in the station to produce a beverage; and a beverage outlet for directing an outflow of beverage from the cavity to the receptacle station; wherein the apparatus comprises a plurality of different beverage outlets that are interchangeable for making different beverages.

U.S. Pat. No. 7,387,063 issued to Vu, et al. a beverage brewing system is adapted to have a brewing configuration, in which, a brewing chamber has a brewing substance therein, a bottle initially has a fluid therein, a lid is located over a cup, the bottle is removable attached to the lid and located over the lid, the brewing chamber is located between the bottle and the cup, and a blow-out valve is located between the bottle and the brewing chamber so that the blow-out valve initially hinders a flow of the fluid from the bottle to the brewing chamber. The blow-out valve is adapted to be breached at a predetermined pressure when the fluid is heated to allow the fluid to pass through the brewing chamber into the cup to form a brewed fluid. The entire system is preferably disposable and microwavable. Preferably, the system has a compact storage configuration and a portable drinking configuration as well.

### SUMMARY OF INVENTION

This invention when used in microwaves in which by simply adding liquid and a cartridge containing any flavored dry beverage, the liquid then is infused with a specific amount of heated liquid to produce a flavor beverage. This beverage cartridge holder comprises a cone shape having opening ports. Two needles internally work as a transporter of the hot liquid. In the first stage liquid is non-flavored and the second transfer is the already flavored beverage. A lid securely closes the top and bottom opening and together they interlock to work as a unit.

### BRIEF DESCRIPTION OF THE DRAWINGS

This product is designed with three main components that perform as a unit:

FIG. 1 The first component is a heating chamber.

FIG. 2 The second component is a lid in accordance to the present invention.

FIG. 3 The third component, the beverage cartridge holder.

FIG. 4 The Microwave Beverage Cartridge Holder assembly.

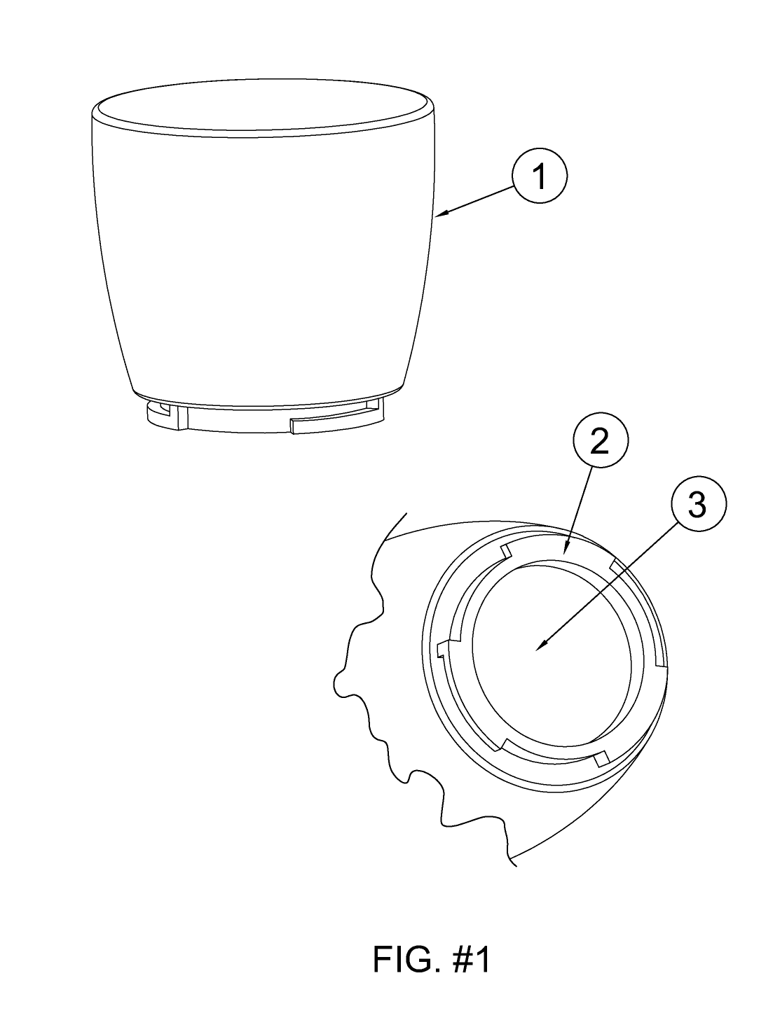

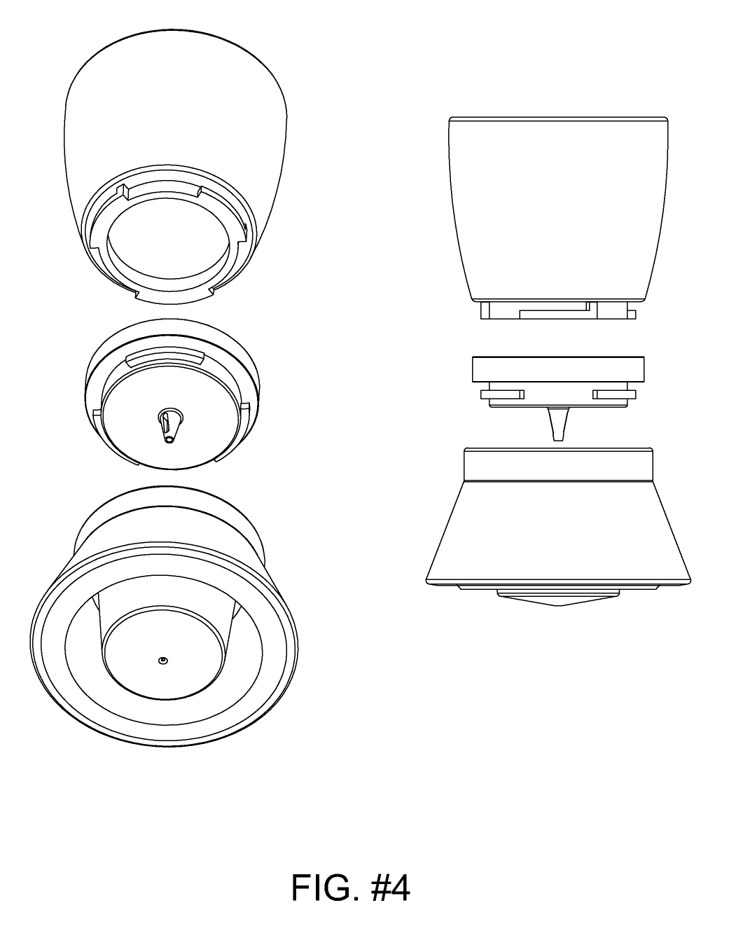

FIG. 1 is an inside view of the heating chamber, an opening port 3, this to allow the transfer of specific amounts of liquid into the third component, the beverage cartridge holder;

a distinct shape 1, to ensure the liquid is transferred through the process of compression to the third component, the beverage cartridge holder;

a male locking system 2, that secures onto the female locking system of the second component, the lid;

an outside view of the heating chamber shape 16, grooves 17 are located around the edge of the heating chamber to allow securing of the lid.

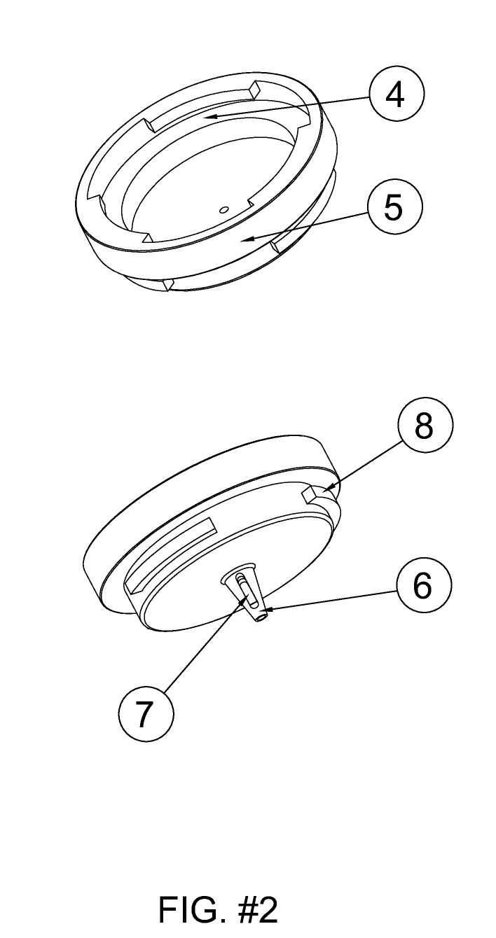

FIG. 2 is a lid, which has a male 8 and a female 4 securing system, in order to keep the liquid securely inside of the heating chamber;

the lid also has grooves around the edge 18, to facilitate closing of the heating chamber;

a liquid transfer needle with a sharp tip 6, which allows transfer of specific amounts of liquid into the third component, the beverage cartridge holder;

a male securing system 8, to attach the third component, the beverage cartridge holder;

a needle tip has a fixed dimension to reach a precise distance allowing penetration into the cartridges and transferring a set amount of liquid through the opening ports 7.

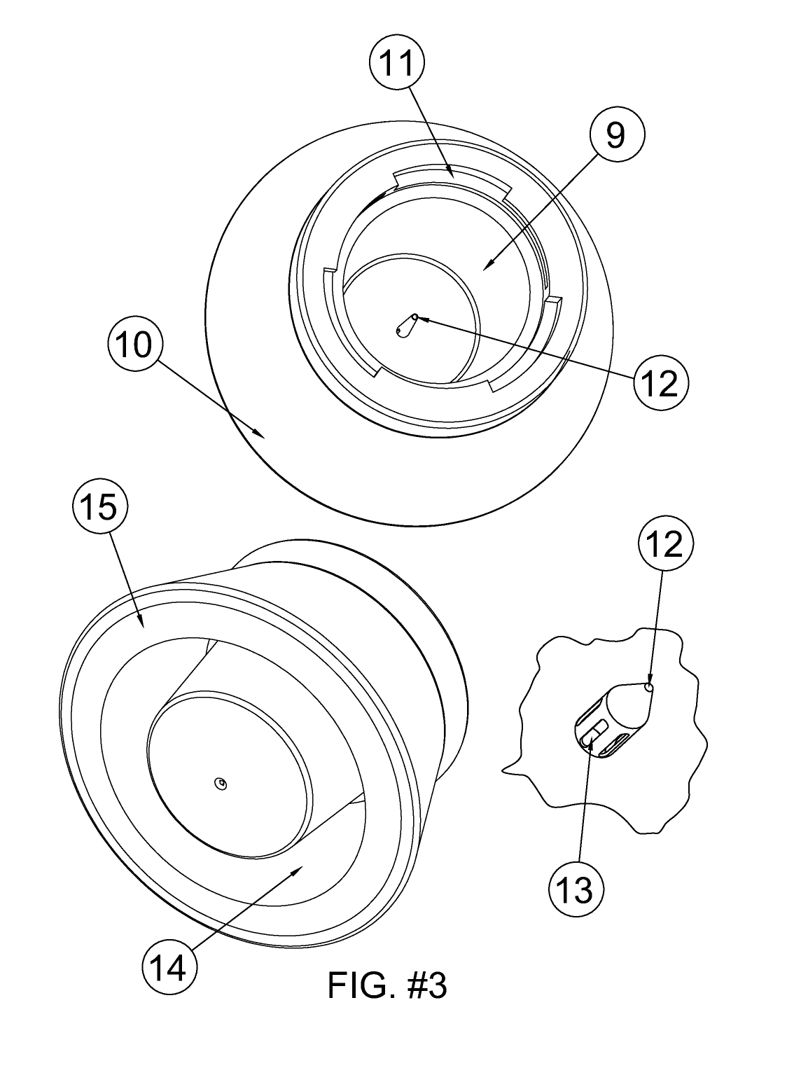

FIG. 3 is an exposed view of the beverage cartridge holder 9;

is the shape of the beverage cartridge holder, designed to grip the beverage cartridges 19;

opening ports of the needle 13, which allows a set amount of liquid through it;

needle sharp tip 12, allows the penetration to the bottom of the cartridges.

I claim:

1. Three main components that perform as a unit to be used in microwaves in which a metered amount of liquid is infuse through a measured amount of dry flavored beverage self contained which serves to produce a hot flavored beverage; a microwave beverage cartridge holder used for retaining the liquid and for the method used said liquid is transferred due to heat reaction inside the chamber the liquid is enclosed:

2. The heating chamber FIG. 1;
a distinct shape inside the heating chamber FIG. 1 (1) to ensure the liquid is transferred through the process of compression to the third component, the beverage cartridge holder;
a male locking system on the heating chamber FIG. 1 (2) that secures onto the female locking system of the lid;
an opening port FIG. 1 (3) on the heating chamber that allows transfer of specific amounts of liquid into the beverage cartridge holder.

3. The lid FIG. 2;
a female securing system on the lid FIG. 2 (4) in order to keep the liquid securely inside of the heating chamber;
grooves around the edge of the lid FIG. 2 (5) to facilitate closing of the heating chamber;
a liquid transfer needle with a sharp tip at the bottom of the heating chamber FIG. 2 (6);
opening ports on the liquid transfer needle FIG. 2 (7);
a male securing system on the bottom of the lid FIG. 2 (8).

4. The beverage cartridge holder FIG. 3 (9);
a grip to secure beverage cartridges FIG. 3 (10);
a female locking system on top of the beverage cartridge holder FIG. 3 (11) ensures the process of enclosing the cartridge and allows the penetration to the top and bottom of the cartridges with the liquid transfer needles;
The needle's sharp tip FIG. 3 (12);
opening ports of the needle FIG. 3 (13) allows a set amount of liquid through the cartridge and dispenses the already flavored beverage into any cup or container;
a cavity FIG. 3 (14) to allow heat to exit the beverage cartridge holder;
a base FIG. 3 (15) to maintain and stabilize the proper level of the product above the cup or container.
